(19) United States
(12) Patent Application Publication
(10) Pub. No.: US 2019/0244262 A1
(43) Pub. Date: Aug. 8, 2019

(54) Bonus calculation method for a sales platform recommendation system

(71) Applicant: Duo Bao, Baotou (CN)

(72) Inventor: Duo Bao, Baotou (CN)

(21) Appl. No.: 16/027,261

(22) Filed: Jul. 3, 2018

(30) Foreign Application Priority Data
Feb. 7, 2018 (CN) 201810120067.7

(51) Int. Cl. G06Q 30/02; G06Q 10/10; G06F 17/10

(52) U.S. Cl. CPC G06Q 30/0283; G06F 17/10; G06Q 10/1053

(57) ABSTRACT

A bonus calculation method for a sales platform recommendation system, comprising the following steps: step 1, user is registered as a member on the sales platform recommendation system, and the user who becomes the member delivers the franchise fee; step 2, the member recommends the system recommendation personnel on the sales platform; step 3, if the referral wants to join, return to step 1; step 4, the referrer sequentially numbers the referrals who are registered as members, and the referrer becomes the superior of the referral; step 5, the franchise fee from referrals is assigned to assigned members, the assigned members include N members who are numbered in front of the referrals, referrers, N members who are numbered in front of the referrers, and superior members of the referrers, N members who are in front of the referrer's superior members and superior members of the referrer's superior members.

### BACKGROUND OF THE INVENTION

### 1. Field of the Invention

The present invention relates to a bonus calculation method for a sales platform recommendation system.

### 2. Description of the Related Art

With the development of the Internet, now there are a variety of sales platforms and sales channels, and there are many sales methods. The distribution of profits or bonuses of the current sales platform is relatively simple. Most of the marketers own profits and bonuses belong to themselves, and there are few associations and interactions between marketers and individuals. This is very unfavorable to the sales platform, and it is impossible to mobilize the enthusiasm and initiative of the members, so it is difficult to greatly increase the franchisees.

### SUMMARY OF THE INVENTION

The present invention has been made to solve the foregoing problems and it is therefore an method of the present invention to provide a bonus calculation method for a sales platform recommendation system.

According to an aspect of the invention to obtain the above method, it is provided a bonus calculation method for a sales platform recommendation system.

A bonus calculation method for a sales platform recommendation system, comprising the following steps:

step 1, user is registered as a member on the sales platform recommendation system, and the user who becomes the member delivers the franchise fee;

step 2, the member recommends the system recommendation personnel on the sales platform;

step 3, if the referral wants to join, return to step 1;

step 4, the referrer sequentially numbers the referrals who are registered as members, and the referrer becomes the superior of the referral;

step 5, the franchise fee from referrals is assigned to assigned members, the assigned members include N members who are numbered in front of the referrals, referrers, N members who are numbered in front of the referrers, and superior members of the referrers, N members who are in front of the referrer's superior members and superior members of the referrer's superior members.

Furthermore, wherein in the step 4, the number is an integer starting from zero, and the numbers increase in sequence, the serial number of prior referrals are smaller than the serial number of later referrals.

Furthermore, wherein N=2.

Furthermore, wherein in the step 5, the number of members whose serial number is in the front of the referrals≥N, the number of members whose serial number is in the front of the referrers≥N, the number of members whose serial number is in the front of the superior members of referrers≥N; the franchise fee of the referrals is evenly distributed to assigned members.

Furthermore, wherein in the step 5, the number of members whose serial number is in the front of the referrals≥N, the number of members whose serial number is in the front of the referrers≥N, the number of members whose serial number is in the front of the superior members of referrers≥N; the amount of the franchise fee obtained by the assigned members is divided into three levels, including the first level, the second level, and the third level, amount of the first level≥amount of the second level≥amount of the third level.

Furthermore, wherein the member who obtains the first level franchise fee is an N member whose number is in front of the referral; the member who obtains the second level franchise fee is an superior member of N member whose number is in front of the referrer; the member who obtains the third level franchise fee is a higher superior member of N member whose number is in front of the referrer.

Furthermore, wherein in the step 5, if the serial number of members whose number is in front of the referrals is less than N, or the serial number of members whose number is in front of the referrers is less than N, or the serial number of superior members whose number is in front of the referrers is less than N, the members whose number is in front of the referrals, the member whose number is in front of the referrers, and the serial number is in front of the superior members of the referrers, the franchise fee are allocated to the members according to the distribution rules, and the remaining franchise fee is allocated to the sales platform.

In conclusion, the beneficial effects of the present invention as follows:

The present disclosure is aim to provide a bonus calculation method for a sales platform recommendation system, the distribution method can mobilize the enthusiasm of the relevant personnel. When there is no performance, it may also receive the corresponding franchise, which can encourage more people to invest in the sales platform, and actively recommend relevant personnel to join the sales platform.

### DETAILED DESCRIPTION OF THE PREFERRED EMBODIMENT

The following detailed description will present a preferred embodiment of the invention in reference to the accompanying embodiment.

The present disclosure provided a bonus calculation method for a sales platform recommendation system, comprising the following steps:

step 1, user is registered as a member on the sales platform recommendation system, and the user who becomes the member delivers the franchise fee;

step 2, the member recommends the system recommendation personnel on the sales platform;

step 3, if the referral wants to join, return to step 1;

step 4, the referrer sequentially numbers the referrals who are registered as members, and the referrer becomes the superior of the referral;

step 5, the franchise fee from referrals is assigned to assigned members, the assigned members include N members who are numbered in front of the referrals, referrers, N members who are numbered in front of the referrers, and superior members of the referrers, N members who are in front of the referrer's superior members and superior members of the referrer's superior members.

### Embodiment 1

The number is an integer starting from zero, and the numbers increase in sequence, the serial number of prior referrals are smaller than the serial number of later referrals, so based on the time of the registration, the serial number of the referrals can be set as (0, 1, 2, 3)

### Embodiment 2

In the embodiment, N=2, so in the step 5, the 2 members whose serial number are in front of the referrals, referrers, the 2 members whose serial number are in front of the referrers, the superior member of referrers, the 2 members whose serial number are in front of the superior members, the higher superior member is the assigned member, the above members can get a piece of the franchise fee.

In other embodiment, N also can be 3, 4, 5 and so on, the franchise fee of referrals are allocated to the related members according to the rules of step 5.

### Embodiment 3

In the embodiment, in the step 5, the number of members whose serial number is in the front of the referrals≥N, the number of members whose serial number is in the front of the referrers≥N, the number of members whose serial number is in the front of the superior members of referrers≥N; the franchise fee of the referrals is evenly distributed to assigned members.

In embodiment 4, in the step 5, the number of members whose serial number is in the front of the referrals≥N, the number of members whose serial number is in the front of the referrers≥N, the number of members whose serial number is in the front of the superior members of referrers≥N; the amount of the franchise fee obtained by the assigned members is divided into three levels, including the first level, the second level, and the third level, amount of the first level≥amount of the second level≥amount of the third level, the member who obtains the first level franchise fee is an N member whose number is in front of the referral; the member who obtains the second level franchise fee is an superior member of N member whose number is in front of the referrer; the member who obtains the third level franchise fee is a higher superior member of N member whose number is in front of the referrer, settle the particular amount, then allocated to related members according to rules, the sum amount of all levels is the total amount of franchise fee.

### Embodiment 5

In the embodiment, in the step 5, if the serial number of members whose number is in front of the referrals is less than N, or the serial number of members whose number is in front of the referrers is less than N, or the serial number of superior members whose number is in front of the referrers is less than N, the members whose number is in front of the referrals, the member whose number is in front of the referrers, and the serial number is in front of the superior members of the referrers, the franchise fee are allocated to the members according to the distribution rules, and the remaining franchise fee is allocated to the sales platform.

The present disclosure is aim to provide a bonus calculation method for a sales platform recommendation system, the distribution method can mobilize the enthusiasm of the relevant personnel. When there is no performance, it may also receive the corresponding franchise, which can encourage more people to invest in the sales platform, and actively recommend relevant personnel to join the sales platform.

The embodiments described above are only for explaining the technical idea and the features of the present invention. The purpose of the present invention is to enable those skilled in the art to understand the contents of the present invention and to implement the present invention. The patent scope of the present invention cannot be limited only by the present embodiment, every equivalent variations or modifications made by the spirit of the invention are still within the scope of the invention.

1. A bonus calculation method for a sales platform recommendation system, comprising the following steps:
step 1, user is registered as a member on the sales platform recommendation system, and the user who becomes the member delivers the franchise fee;
step 2, the member recommends the system recommendation personnel on the sales platform;
step 3, if the referral wants to join, return to step 1;
step 4, the referrer sequentially numbers the referrals who are registered as members, and the referrer becomes the superior of the referral;
step 5, the franchise fee from referrals is assigned to assigned members, the assigned members include N members who are numbered in front of the referrals, referrers, N members who are numbered in front of the referrers, and superior members of the referrers, N members who are in front of the referrer's superior members and superior members of the referrer's superior members.

2. A bonus calculation method for a sales platform recommendation system of claim 1, wherein in the step 4, the number is an integer starting from zero, and the numbers increase in sequence, the serial number of prior referrals are smaller than the serial number of later referrals.

3. A bonus calculation method for a sales platform recommendation system of claim 1, wherein N=2.

4. A bonus calculation method for a sales platform recommendation system of claim 1, wherein in the step 5, the number of members whose serial number is in the front of the referrals≥N, the number of members whose serial number is in the front of the referrers≥N, the number of members whose serial number is in the front of the superior members of referrers≥N; the franchise fee of the referrals is evenly distributed to assigned members.

5. A bonus calculation method for a sales platform recommendation system of claim 1, wherein in the step 5, the number of members whose serial number is in the front of the referrals≥N, the number of members whose serial number is in the front of the referrers≥N, the number of members whose serial number is in the front of the superior members of referrers≥N; the amount of the franchise fee obtained by the assigned members is divided into three levels, including the first level, the second level, and the third level, amount of the first level≥amount of the second level≥amount of the third level.

6. A bonus calculation method for a sales platform recommendation system of claim 5, wherein the member who obtains the first level franchise fee is an N member whose number is in front of the referral; the member who obtains the second level franchise fee is an superior member of N member whose number is in front of the referrer; the member who obtains the third level franchise fee is a higher superior member of N member whose number is in front of the referrer.

7. A bonus calculation method for a sales platform recommendation system of claim 1, wherein in the step 5, if the serial number of members whose number is in front of the referrals is less than N, or the serial number of members whose number is in front of the referrers is less than N, or the serial number of superior members whose number is in front of the referrers is less than N, the members whose number is in front of the referrals, the member whose number is in front of the referrers, and the serial number is in front of the superior members of the referrers, the franchise fee are allocated to the members according to the distribution rules, and the remaining franchise fee is allocated to the sales platform.
